(19) United States
(12) Patent Application Publication
(10) Pub. No.: US 2003/0086701 A1
(43) Pub. Date: May 8, 2003

(54) Trap assembly for use with a purge and trap

(76) Inventor: Martin B. Motz, Cincinnati, OH (US)

Correspondence Address: Christopher R. Christenson, WESTMAN CHAMPLIN & KELLY, International Centre - Suite 1600, 900 South Second Avenue, Minneapolis, MN, 55402-3319, US

(21) Appl. No.: 10/007,553

(22) Filed: Nov. 8, 2001

(51) Int. Cl. F24H 1/08

(52) U.S. Cl. 392/479; 392/472; 219/544

(57) ABSTRACT

A trap heater for a purge and trap. The heater includes a metal tube with a heat transfer surface around a central trap passageway. An electrical insulating layer is formed on the heat transfer surfaces. A heating element is formed on the electrical insulating layer. The heating element has a serpentine path and a rectangular cross section, with a wider side of the rectangular cross section contacting the electrical insulating layer.

### FIELD OF THE INVENTION

The present invention relates to traps such as those used in purge and trap equipment that supplies samples to a chromatograph. In particular, the present invention relates to trap heaters for traps.

### BACKGROUND OF THE INVENTION

In chromatography, a carrier carries a mixture of unknown chemicals through a chromatograph column. The column includes a tube packed with a bed of chemically adsorbent material. Each chemical moves through the column at a different rate depending on its interaction with the carrier and the adsorbent. Each chemical flows out of the column at a different time. The chemicals flowing out of the column are provided to a chemical detector as a series of peaks of chemical concentrations. The peaks are separated in time, and each peak represents a different chemical compound. The chemical detector, which typically includes a thermal conductivity cell or a flame ionization detector, can identify or quantify the peaks of the individual chemical compounds.

With some types of samples, purge and trap equipment, such as a Tekmar Model 3000 or 3100, is used to provide the sample and carrier gas to the chromatograph. The purge and trap equipment includes a trap that adsorbs sample while the trap is cool and that releases the sample to the chromatograph when the trap is rapidly heated by a trap heater. This arrangement ensures that all of the components are driven off from the trap at substantially the same time. The chromatograph is able to operate optimally when the various components of a sample reach the chromatograph substantially at the same time.

The trap heater surrounds the trap, which is usually a metal tube packed with one or more adsorbent materials. The trap heater typically includes a metal tube that slides over the trap tube and includes an outer electrical heating element of round nichrome wire wound on the metal tube as illustrated in FIGS. 1, 2.

Chemical sample handlers and chromatographs are increasing in speed and accuracy and there is a need to also improve the speed and accuracy of the purge and trap equipment. The existing trap heater, however, is a barrier to increasing speed and accuracy. The existing trap heater is wound using hand methods and the spacing of the turns and the thermal contact with the metal tube are not precisely controlled. These hand methods lead to unpredictability in the heating time of the adsorbent bed in the trap. The round nichrome wire makes limited thermal contact to the surface of the metal tube and tends to couple an excessive proportion of heat to the surrounding environment, which causes heating of the adsorbent bed in the trap to be slow. The nichrome wire is electrically insulated with fiberglass tubing, which is not a good thermal conductor, and which also tends to slow both heating and cooling of the adsorbent bed.

An improved heated trap assembly is needed that has improved speed of both heating and cooling and that has improved predictability and controllability of temperature rise and fall along the length of the trap.

### SUMMARY OF THE INVENTION

An improved heated trap assembly is disclosed. The trap assembly includes a trap and a trap heater. The trap heater includes a metal tube with a heat transfer surface arranged around a central passageway that is slid over the trap. An electrical insulating layer is formed on the heat transfer surface. A heating element is formed on the electrical insulating layer. The heating element has a serpentine path and a generally rectangular cross section. A wider side of the rectangular cross sections contacts the electrical insulating layer.

### BRIEF DESCRIPTION OF THE DRAWINGS

FIG. 1 illustrates a PRIOR ART trap heater.

FIG. 2 illustrates a PRIOR ART arrangement of heating elements on a trap heater.

FIG. 3 illustrates an installation environment for a heated trap assembly in purge and trap equipment.

FIG. 4 illustrates a front cross sectional view of a trap heater mounted on a trap.

FIG. 5 illustrates a top cross sectional view of the arrangement shown in FIG. 4.

FIG. 6 illustrates a rectangular cross section of a heating element on a metal substrate.

FIG. 7 illustrates a partial sectional view of an alternative trap heater with multiple heat zones.

FIG. 8 schematically illustrates multiple trap heaters mounted on a trap.

FIG. 9 illustrates a front view of a first alternative embodiment of a trap heater that includes a radiant heater.

FIG. 10 illustrates a top view the trap heater shown in FIG. 9.

FIG. 11 illustrates a front view of a second alternative embodiment of a trap heater that includes a radiant heater.

### DETAILED DESCRIPTION OF THE PREFERRED EMBODIMENTS

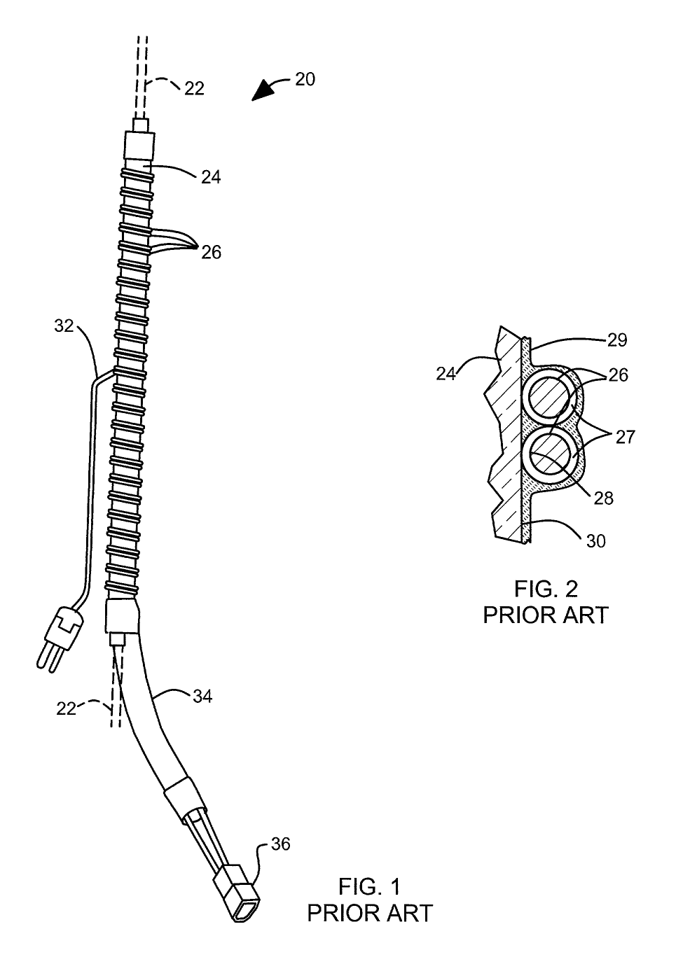

FIGS. 1-2 illustrate a PRIOR ART trap heater 20. The trap heater 20 surrounds a trap tube 22 that is packed with a bed of adsorbent material (not illustrated in FIG. 1). The trap heater 20 includes a metal tube 24 that slides over the trap tube 22 and an outer electrical heating element 26 of round nichrome wire wound on the metal tube 24 as illustrated. The electrical heating element 26 is electrically insulated from the metal tube 24 by fiberglass sleeving 27. The electrical heating element 26 is held in place by a layer of ceramic coating 29 that is applied with a brush.

The heating element 26 is wound using hand methods and the spacing and the contact of the wire turns of the heating element 26 with the metal tube 24 are not precisely controlled. These hand methods lead to unpredictability in the heating time of the adsorbent bed in the trap tube 22. As illustrated in FIG. 2, the round nichrome wire 26 makes limited thermal contact at locations 28 to the surface 30 of the metal tube 24 and tends to couple an excessive proportion of heat to the surrounding environment, which causes heating of the adsorbent bed to be slow. The metal tube 24 has a significant thermal mass, which also tends to slow both heating and cooling of the adsorbent bed.

A thermocouple 32 is provided for closed loop control of heating element 26. Heater element 26 is connected via cable 34 and connector 36 to a source of current (not illustrated) that is controlled to turn the heater on and off.

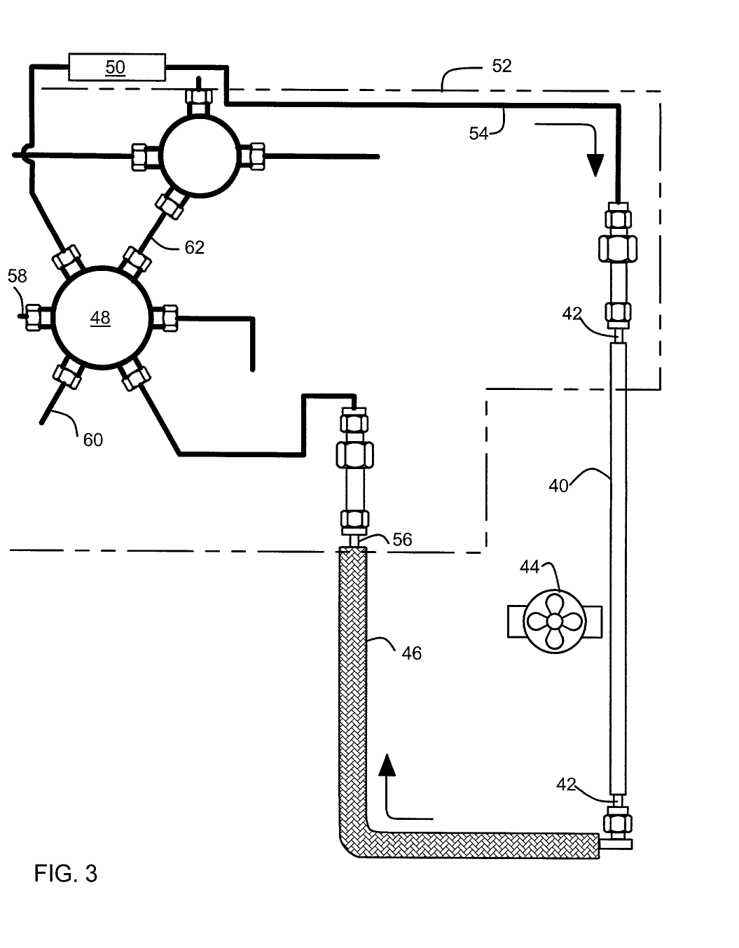

FIG. 3 illustrates a typical installation environment for an improved trap heater 40. It will be understood by those skilled in the art that traps and trap heaters are used in a variety of trapping arrangements, and that use of the improved trap heater 40 is not limited to the example illustrated in FIG. 3.

A line 60 provides a solvent or carrier gas to a six port valve 48. A line 62 provides a sample chemical mixture to the six port valve 48. The solvent carries the mixture of unknown chemicals and the solvent from the six port valve 48 through a moisture removal system 50 and through a line 54 to a trap 42. The trap 42 includes a tube packed with a bed of chemically adsorbent material. Depending on the application, the bed of adsorbent material may include multiple layers of different adsorbent material spaced along the length of the trap 42. Some of the multiple layers adsorb lighter components of the sample, while other layers adsorb heavier components of the sample. Each chemical is adsorbed by the trap at a different time rate depending on its interaction with the solvent and the adsorbent. Each chemical flows out of the trap along line 56, however at substantially the same time to the six port valve 48 when the trap 42 is heated by the trap heater 40. Line 56 is thermally insulated with insulation 46. The simultaneously released chemicals flow from line 56 through six port valve 48 to a heated outlet line 58 which leads to a chromatograph (not illustrated). The improved trap heater 40 and a cooling fan 44 are electrically controlled to operate at different times to heat the trap 42 to speed up movement of chemicals out the trap 42, and to cool down the trap 42 in preparation for the next sample measurement. A heated oven 52 maintains the six port valve 48 and other lines at a controlled temperature.

Chemical sample handlers and chromatographs are increasing in speed and accuracy and there is a need to also improve the speed and accuracy of the purge and trap process. The existing trap heater, however, is a barrier to increasing speed and accuracy as explained above in connection with FIGS. 1-2. The improved trap heater 40, illustrated only schematically in FIG. 3, solves these problems and provides improved performance.

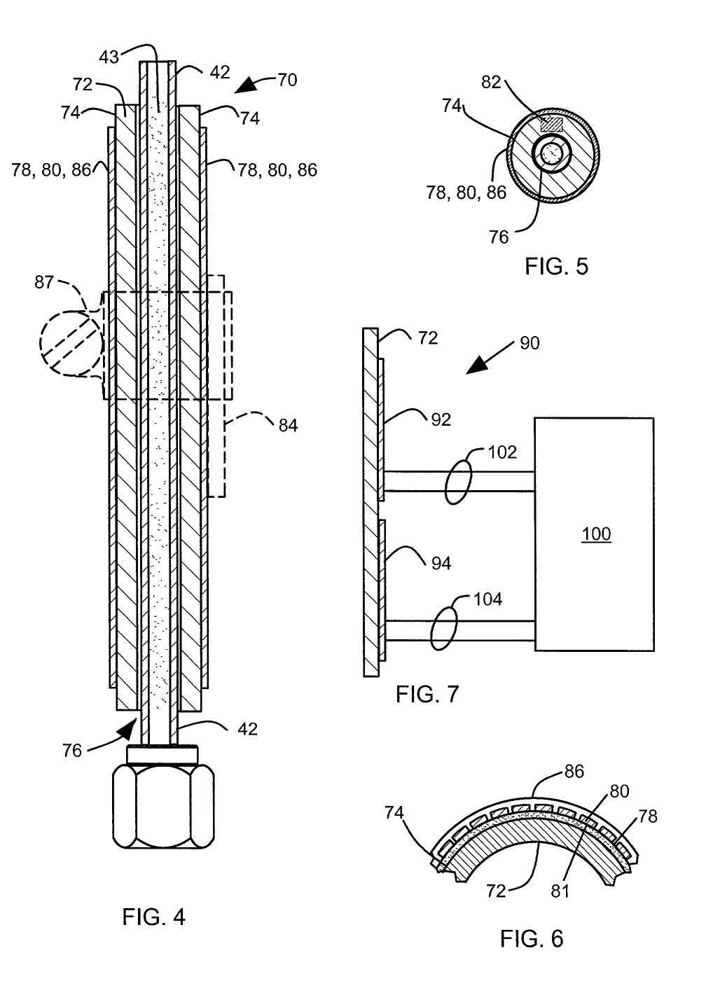

Examples of the improved trap heater 40 are explained in more detail below in connection with FIGS. 4-8. Heated traps illustrated below in FIGS. 4-8 can provide improved speed of both heating and cooling and have improved predictability and controllability of temperature rise and fall along the length of the trap. Improved trap heaters 40 are formed from a metal tube, preferably aluminum or high thermal conductivity stainless steel, that has high thermal conductivity.

FIGS. 4-6 illustrate a first embodiment of a trap heater 70 mounted on a trap that includes trap tube 42 and adsorbent bed 43. In a preferred arrangement, the adsorbent bed 43 includes multiple layers spaced along the length of the tube 42, with a layer that adsorbs lighter components of a sample, and a layer that adsorbs heavier components of a sample. The trap heater 70 comprises a metal tube 72 having a heat transfer surface 74 arranged around a central passageway 76 adapted to be slid over the trap tube 42. The trap heater 70 also includes thin electrical insulating layer 78 formed on the heat transfer surface 74. Metal tube 72 is preferably only of sufficient size to provide large enough heat transfer surfaces 74 for heating the trap. The insulating layer 78 is preferably only as thick as is needed to provide electrical insulation. The thermal mass of the trap heater 70 is kept small.

Heating element 80 is formed on the electrical insulating layer 78. Heating element 80 is preferably formed from a conductive ink or paste. The heating element 80 has a serpentine path that distributes heating over the heat transfer surface 74. The heating element 80 has a generally rectangular cross section, with a wider side 81 of the rectangular cross section contacting the electrical insulating layer 78 as illustrated in FIG. 6. Placing the wider side 81 in contact with the insulating layer provides increased heat transfer to the tube 70 and reduces heat transfer to the surrounding air in comparison with the round wires illustrated in FIG. 2.

A temperature sensor 82 (shown in FIG. 5) thermally couples directly to an end of the metal tube 72.

If desired, the temperature sensor 82 can also be placed at optional location 84 and can be held in place with a clamp at location 87. In this optional location 84, the temperature sensor 82 couples indirectly to the metal tube 72 through insulating layers 78, 86. As illustrated in FIG. 6, an optional cover layer 86 of electrical insulating material can be formed over heating element 80.

In a preferred arrangement, the temperature sensor 82 comprises a thin film platinum resistance temperature detector (RTD). Temperature sensor 82 can also be a thermocouple or other known temperature sensor.

The heating element 80 can be formed by any of various known methods of forming heating elements. The heating elements 80 can comprise thick film elements, etched metal foils, or can be selectively plated on the layer 78 of electrical insulating material. The watt density of the heating elements can be different along the length of the tube 72 to provide different heating characteristics for different portions of the bed of adsorbent material 43. This feature of different watt densities is particularly useful when the bed of adsorbent material 43 has a composition that also varies along the length of the tube 72. The different watt densities are adjusted by providing different widths of serpentine paths of heating element 80 along the length of tube 72, or by varying the thickness of heating element 80 along the length of the tube 72, or any combination of these methods.

The heat transfer surface 74 preferably comprises a smooth cylindrical surface that runs along the length of the metal tube 72 as illustrated. The smooth surface provides for convenient deposition of insulating materials 78, 86 and heating elements 80. The smooth surface also facilitates good heat conduction. The cross-sectional shape of metal tube 72 can vary depending on the needs of the application.

Electrical insulating layers 78, 86 can be alumina or other compatible materials and can be formed using know deposition methods such as chemical deposition, plasma spraying or growth of an oxide on an underlying substrate. When metal tube 72 is formed of aluminum, the surface of the aluminum can be oxidized to provide the insulation layer 78. Various types of known insulating glasses can be used as well. Examples of processes and materials for applying layers 78, 80, 86 by thick film methods are illustrated in U.S. Pat. No. 6,222,166 Lin et al. and in U.S. patent application No. 2001/0014373A1 Lin et al. Heating element 80 can be formed of a metal-based paste such as Electro-Science Laboratories Inc. ESL 590. The insulating layer 78 can be formed of aluminum oxide and the metal tube 72 can be formed of aluminum.

FIG. 7 illustrates a partial sectional view of an alternative trap heater 90 with multiple heat zones formed using two heating elements 92, 94, each arranged as explained in connection with FIGS. 4-6. The two heating elements can have different watt densities per unit length of tube 72 to provide varied heat densities along the length of the tube 72. The different watt densities can be accomplished by heating element 92 having a different resistance than heating element 94, by providing heating element 92 with a different electrical excitation level than heating element 94, by providing a different length of heating time for heating element 92 than heating element 94, or by a combination of these methods. Leads 102 connect heating element 92 to a controller 100. Leads 104 connect heating element 94 to the controller 100. Controller 100 provides individual control of the timing and amplitude of currents supplied on leads 102, 104. Controller 100 can also be used to control switching a fan on and off, such as fan 44 in FIG. 3. Temperature sensor 82 is preferably connected to controller 100 as well.

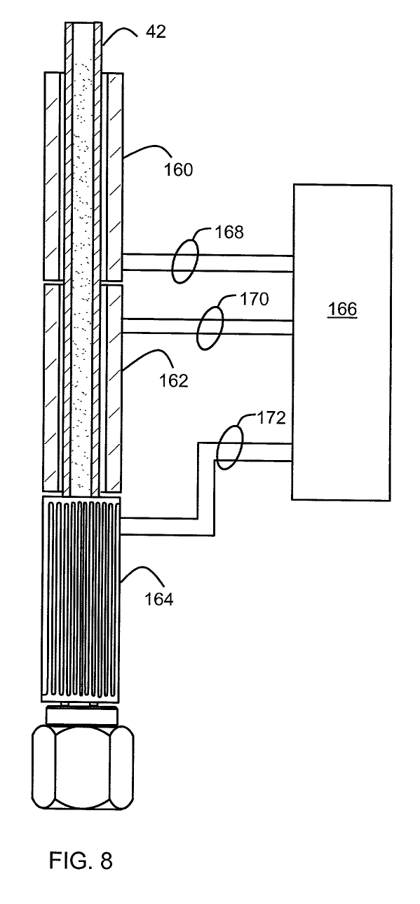

FIG. 8 schematically illustrates multiple trap heaters 160, 162, 164 mounted on a trap 42. Each trap heater 160, 162, 164 has a length that is shorter than the length of the trap 42 and is configured to be stacked together with one or more other heaters on the trap 42. In a preferred arrangement, the first trap heater 160 has a first watt density per unit length and the second trap heater 162 has a second watt density per unit length, and the third trap heater 164 has a third watt density per unit length. The first watt density is different than the second watt density, and the third watt density is also different. Each trap heater 160, 162, 164 can be aligned with a different composition of adsorbent material in the bed of adsorbent material 43. The different watt densities can be accomplished by heating element 160 having a different resistance than heating elements 162, 164, by providing heating element 160 with a different electrical excitation level than heating elements 162, 164, by providing a different length of heating time for heating element 160 than heating elements 162, 164, or a combination of these methods. Leads 168 connect heating element 160 to a controller 166. Leads 170 connect heating element 162 to the controller 166. Leads 172 connect heating element 164 to the controller 166. Controller 100 provides individual control of the timing and amplitude of currents supplied on leads 168, 170, 172. Controller 100 can provide different watt densities, and can also provide time sequencing of the heating.

Multiple heaters, each with substantially the same watt density, can be separately controlled to provide independently controllable temperatures and timing in multiple zones along the tube.

Those skilled in the art will recognize that materials and processes described in FIGS. 4-8 in connection with one embodiment can be appropriately applied to other embodiments.

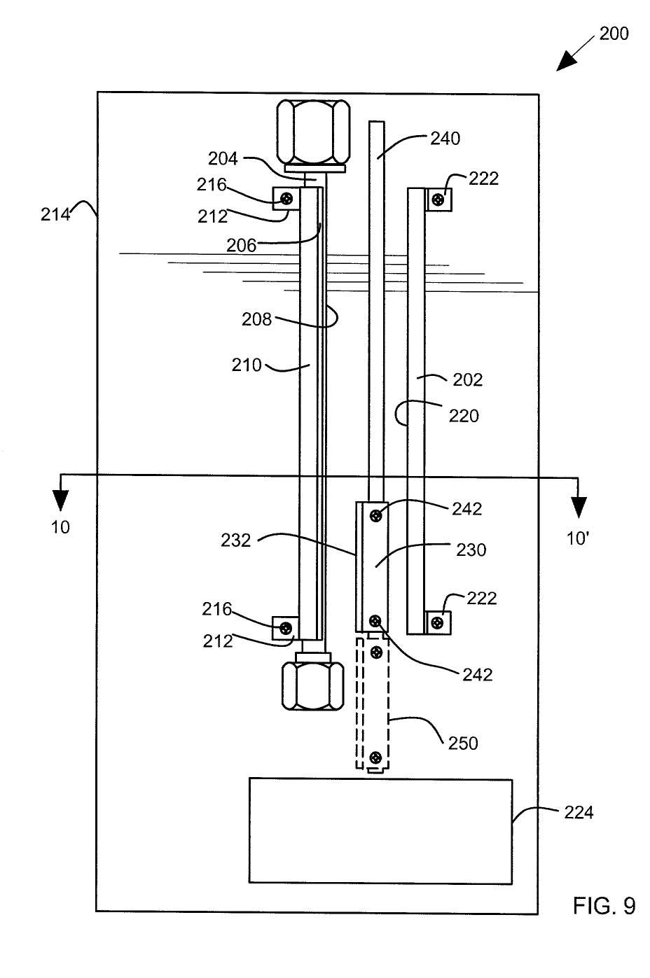

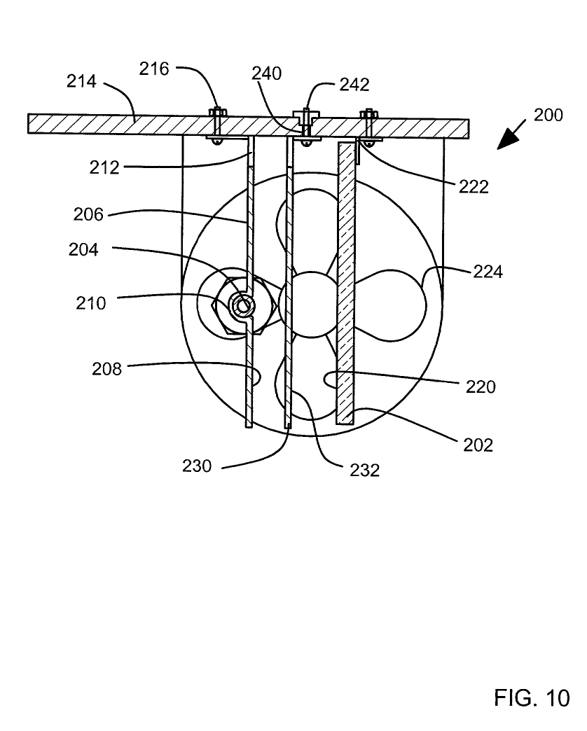

FIGS. 9-10 illustrate a front view and a top sectional view of a first alternative embodiment of a trap heater assembly 200 that includes a radiant heater element 202. The trap heater assembly 200 includes a trap 204 of conventional design. A metal fin 206 engages the trap 204 and has a heat transfer surface 208. The metal fin 206 is preferably formed of sheet aluminum and includes an omega-shaped portion (Ω) 210 that snaps onto the trap 204 to provide good thermal contact between the trap 204 and the metal fin 206. The metal fin 206 also preferably includes tabs 212 that are fastened to a back plate 214 by screws 216 for mechanical support. The tabs 212 are made narrow to reduce thermal conduction to the back plate 214. The metal fin 206 is preferably coated with flat black paint or other coatings that adsorb infrared radiation.

The radiant heating element 202 has a heat radiating surface 220 arranged to face the heat transfer surface 208. Mounting tabs 222 support the heat-radiating surface 220 in a spaced-apart relationship to the heat transfer surface 208. The radiant heating element 202 is electrically energized and controlled to provide a desired sequence of radiant heating to the heat transfer surface. In a preferred embodiment an electrically energized and controlled fan 224 is also provided to provide a desired sequence of cooling to the heat transfer surface 208.

A shade 230 is interposed between the heat transfer surface 208 and the heat radiating surface 220. The shade has a heat shading surface 232 that is smaller than the heat transfer surface 208. The heat shading surface 232 of shade 230 is movable to shade a selected portion of the heat transfer surface 208 from the heat radiating surface 220. Shade 230 is mounted to a slot 240 in back plate 214 and can be slid to a desired position in slot 240 and then secured using screws 242. Shade 232 is preferably constructed of a reflective sheet material such as stainless steel.

In the trap assembly 200, the thermal mass associated with the trap 204 is low because it does not include the thermal mass of the radiant heating element 202. The trap 204 can thus be very rapidly heated by thermal radiation. The trap 204 will also naturally cool quickly because of the low thermal mass associated with it. In a preferred embodiment, the trap 204 can be even more rapidly cooled by fan 224. The shade 232 allows for varying the heating along the length of the trap 204. Alternatively, the shade 230 can be slid to a storage position 250, and then the full length of the trap 204 can be uniformly heated.

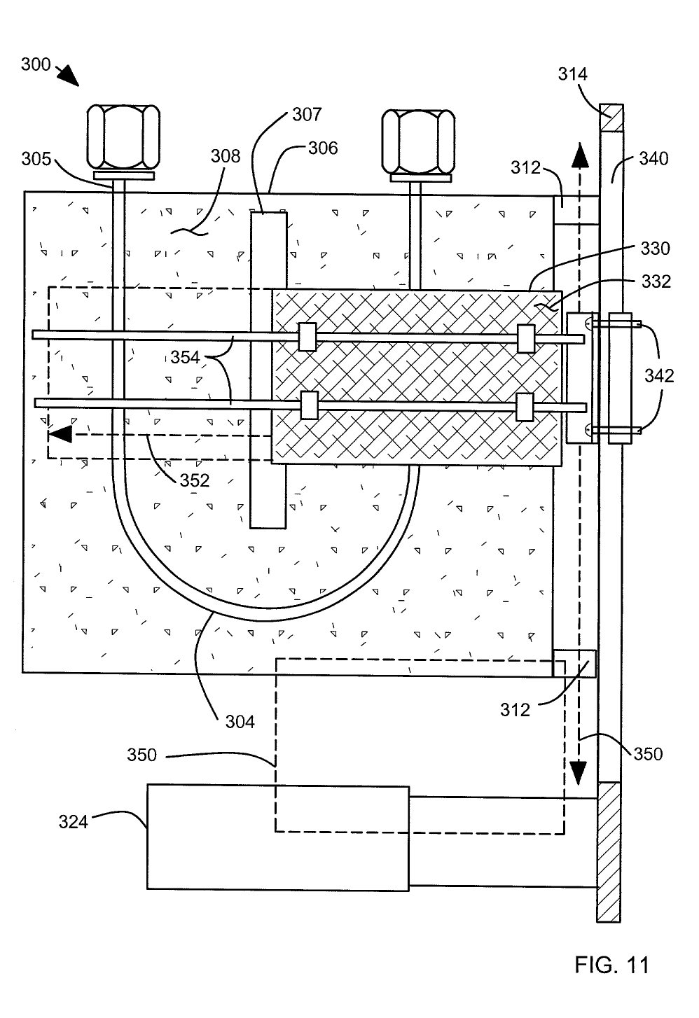

FIG. 11 illustrates a side view of a first alternative embodiment of a trap heater assembly 300 that includes a radiant heater element (not illustrated in FIG. 3, but similar to radiant heater element 202 in FIGS. 9-10). The trap assembly shown in FIG. 11 is similar to the trap assembly 200 illustrated in FIGS. 9-10, however, the trap heater assembly illustrated in FIG. 11 includes a generally U shaped trap and a shade that is movable along two mutually perpendicular axes 350, 352.

The trap assembly 300 includes a trap 304 that is generally U shaped. The U shape helps avoid cold spots at the outlet end 305 of the trap 304. A metal fin 306 is soldered to the trap 304 and has a heat transfer surface 308. The metal fin 306 is preferably formed of sheet aluminum and is in good thermal contact between the trap 304. The metal fin includes a slot 307 reduces flow of heat through the metal fin transverse to the slot. The metal fin 306 also preferably includes tabs 312 that are fastened to a back plate 314 by screws for mechanical support. The tabs 312 are made narrow to reduce thermal conduction to the back plate 314. The metal fin 306 is preferably coated with flat black paint or other coatings that adsorb infrared radiation.

As in FIGS. 9-10, a radiant heating element (not shown in FIG. 11) has a heat radiating surface arranged to face the heat transfer surface 308. Mounting tabs support the heat-radiating surface in a spaced-apart relationship to the heat transfer surface 308. The radiant heating element is electrically energized and controlled to provide a desired sequence of radiant heating to the heat transfer surface. In a preferred embodiment an electrically energized and controlled fan 324 is also provided to provide a desired sequence of cooling to the heat transfer surface 308.

A shade 330 is interposed between the heat transfer surface and the heat radiating surface 320. The shade has a heat shading surface 332 that is smaller than the heat transfer surface 308. The heat shading surface 332 of shade 330 is movable to shade a selected portion of the heat transfer surface 308 from the heat radiating surface. Shade 330 is mounted to a slot 340 in back plate 314 and can be slid along axis 350 to a desired position in slot 340 and then secured using screws 342. Shade 330 is slidably mounted on rods 354 and can also be moved to a desired position along axis 352. Shade 332 is preferably constructed of a reflective sheet material such as stainless steel. The trap 304 is generally U-shaped and the shade 330 is movable in two mutually perpendicular directions 350, 352 to shade selected portions of the U-shaped trap 304.

In the trap assembly 300, the thermal mass associated with the trap 304 is low because it does not include the thermal mass of the radiant heating element. The trap 304 can thus be very rapidly heated by thermal radiation. The trap 304 also naturally cools very rapidly because of its low thermal mass. In a preferred embodiment, the trap 304 can also be even more rapidly cooled by fan 324. The shade 332 allows for varying the heating along the length of the trap 304. Alternatively, the shade 330 can be slid to a storage position 350, and then the full length of the trap 304 can be uniformly heated.

Although the present invention has been described with reference to preferred embodiments, workers skilled in the art will recognize that changes may be made in form and detail without departing from the spirit and scope of the invention.

What is claimed is:

1. A trap assembly, comprising:
a trap;
a metal tube having a heat transfer surface arranged around a central passageway that slidingly engages the trap;
an electrical insulating layer formed on the heat transfer surface; and
a heating element formed on the electrical insulating layer, the heating element having a serpentine path and a generally rectangular cross section, with a wider side of the rectangular cross section contacting the electrical insulating layer.

2. The trap assembly of claim 1, further comprising:
a temperature sensor thermally coupled to the metal tube.

3. The trap assembly of claim 2 wherein the temperature sensor comprises a thin film platinum resistance temperature detector (RTD).

4. The trap assembly of claim 1, further comprising:
a cover layer of electrical insulating material formed over the heating element.

5. The trap assembly of claim 1 wherein the heating element comprises a thick film element.

6. The trap assembly of claim 1 wherein the heating element comprises an etched metal foil.

7. The trap assembly of claim 1 wherein the heating element comprises a metal layer selectively plated on the layer of electrical insulating material.

8. The trap assembly of claim 1 wherein the heat transfer surface comprises a smooth surface.

9. The trap assembly of claim 8 wherein the smooth surfaces runs along the length of the metal tube.

10. The trap assembly of claim 9 wherein the heating element has a watt density per unit length that varies along the length of the smooth face.

11. The trap assembly of claim 1 wherein the trap heater has a length that is shorter than the length of the trap and is configured to be stacked with a second such trap heater on the trap.

12. The trap assembly of claim 11 wherein the trap assembly has a first watt density per unit length and the second trap heater has a second watt density per unit length, and the first watt density is different than the second watt density.

13. The trap assembly of claim 12 further comprising a controller providing individual excitation to the first and second trap heaters.

14. A trap assembly, comprising:
a trap;
a metal fin that engages the trap and has a heat transfer surface;
a radiant heating element having a heat radiating surface arranged to face the heat transfer surface, the heat radiating surface being supported in a spaced-apart relationship to the heat transfer surface; and
a shade interposed between the heat transfer surface and the heat radiating surface, the shade having a heat shading surface that is smaller than the heat transfer surface, the heat shading surface being movable to shade a selected portion of the heat transfer surface from the heat radiating surface.

15. The trap assembly of claim 14, wherein the trap is generally U-shaped and the shade is movable in two mutually perpendicular directions to shade selected portions of the U-shaped trap.
